(19) United States
(12) Patent Application Publication
(10) Pub. No.: US 2008/0002555 A1
(43) Pub. Date: Jan. 3, 2008

(54) Optical pickup and optical disc apparatus

(75) Inventors: Kengo Hayasaka, Tokyo (JP); Takashi Nakao, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/809,594

(22) Filed: Jun. 1, 2007

(30) Foreign Application Priority Data
Jun. 6, 2006 (JP) JP2006-157634

(51) Int. Cl. G11B 7/135; G11B 7/00

(52) U.S. Cl. 369/112.24

(57) ABSTRACT

An optical pickup irradiating a multi-layered optical disc with light to receive a beam reflected from the layer, which includes an objective lens, a condenser lens, a polarization optical element including boundary surfaces positioned backward and forward the focal point of focused light condensed by the condenser lens to change the polarization direction of stray light by reflecting only the stray light with the boundary surfaces, a polarization beam splitter for separating the stray light from focused light based on the polarization direction, a photo detector having a plurality of light receiving regions for detecting the amount of the stray light separated by the polarization beam splitter, and a signal processor for determining the kind of the optical disc on the basis of the amounts of the stray light respectively detected in the plurality of light receiving regions.

### CROSS REFERENCES TO RELATED APPLICATIONS

The present invention contains subject matter related to Japanese Patent Application JP 2006-157634 filed in the Japanese Patent Office on Jun. 6, 2006, the entire contents of which are incorporated herein by reference.

### BACKGROUND OF THE INVENTION

1. Field of the Invention

The present invention relates to an optical pickup and an optical disc apparatus, and in particular relates to an optical pickup and an optical disc apparatus preferably corresponding to an optical disc with a plurality of recording layers.

2. Description of the Related Art

In order to increase the recording capacity of an optical disc, a multi-layered optical disc made by stacking a plurality of recording layers has been proposed. When a signal is recorded on and reproduced from such a multi-layered optical disc, a light beam condensed by an objective lens of the optical pickup is focused on a target recording layer.

When information is recorded on and reproduced from the multi-layered optical disc, it is necessary to regulate the power of a light beam in accordance with the position of a target recording layer and to correct the spherical aberration of the light beam corresponding to the thickness of a cover layer, which differs depending on the position of the target recording layer.

Recently, in order to further increase the recording capacity, Blu-ray Disc™ (referred to as BD below) including blue-violet semiconductor laser with a wavelength of about 405 nm and an objective lens with a numerical aperture of 0.85 has been put to practical use. Then, a multi-formatted optical disc apparatus has been developed in that in addition to conventional DVDs (digital versatile discs) and CDs (compact discs), the BD can be used.

In such an optical disc apparatus, it is necessary to quickly determine the number of layers of a mounted optical disc. Thus, an optical disc apparatus has been proposed in that the light (i.e., stray light) reflected from positions other than an in-focus recording layer, on which a light beam is focused, is received on an independent photo detector for detecting stray light, and the number of layers is determined based on the amount of the detected stray light (see Japanese Patent Laid-Open No. 2006-31773, for example).

### SUMMARY OF THE INVENTION

However, in the optical disc apparatus mentioned above, the stray light becomes incident in a photo detector for detecting a signal together with the focused beam reflected from the in-focus recording layer so as to deteriorate the quality of the detected signal, while the focused beam enters the photo detector for detecting stray light so as to deteriorate accuracies in determining the number of layers.

The present invention has been made in view of such problems, and it is desirable to propose an optical pickup and an optical disc apparatus capable of securely determining the kind of a multi-layered optical disc.

According to an embodiment of the present invention, there is provided an optical pickup configured to irradiate an optical disc having a plurality of recording layers with a light beam to receive a reflected light beam reflected from the recoding layer of the optical disc, in which the optical pickup includes an objective lens configured to condense the light beam emitted from a light source onto an in-focus recording layer of the optical disc and to receive the reflected light beam; a condenser lens configured to condense the reflected light beam received by the objective lens; a polarization optical element configured to include boundary surfaces positioned backward and forward a focal point of focused light condensed by the condenser lens, the focused light being reflected by the in-focus recording layer in the reflected light beam on a plane including the optical axis of the reflected light beam condensed by the condenser lens, and spaced from the focal point by a predetermined distance so as to change the polarization direction of stray light included in the reflection light beam by reflecting only the stray light in the reflected light beam reflected from a non in-focus recording layer by the boundary surfaces; a polarization beam splitter configured to separate the stray light from the focused light based on the polarization direction by emitting the reflected light beam emitted from the polarization optical element therein; a photo detector for detecting stray light having a plurality of light receiving regions for detecting the amount of the stray light separated by the polarization beam splitter; and a signal processor for determining the kind of the optical disc on the basis of the amounts of the stray light respectively detected in the plurality of light receiving regions.

The polarization optical element changes the polarization direction of only the stray light, and the stray light is separated from the focused light by the polarization beam splitter, so that by emitting only the stray light to the photo detector for detecting stray light, the kind determination of the optical disc can be securely executed based on the amount of the stray light.

According to the embodiment of the present invention, there is provided an optical disc apparatus configured to irradiate an optical disc having a plurality of recording layers with a light beam to receive a reflected light beam reflected from the recoding layer of the optical disc, in which the optical disc apparatus includes an objective lens configured to condense the light beam emitted from a light source onto an in-focus recording layer of the optical disc and to receive the reflected light beam; a condenser lens configured to condense the reflected light beam received by the objective lens; a polarization optical element configured to include boundary surfaces positioned backward and forward the focal point of focused light condensed by the condenser lens, the focused light being reflected by the in-focus recording layer in the reflected light beam on a plane including the optical axis of the reflected light beam condensed by the condenser lens, and spaced from the focal point by a predetermined distance so as to change the polarization direction of stray light included in the reflection light beam by reflecting only the stray light in the reflected light beam reflected from a non in-focus recording layer by the boundary surfaces; a polarization beam splitter configured to separate the stray light from the focused light based on the polarization direction by emitting the reflected light beam emitted from the polarization optical element therein; a photo detector for detecting stray light having a plurality of light receiving regions for detecting the amount of the stray light separated by the polarization beam splitter; and a signal processor for determining the kind of the optical disc on the basis of the amounts of the stray light respectively detected in the plurality of light receiving regions.

The polarization optical element changes the polarization direction of only the stray light, and the stray light is separated from the focused light by the polarization beam splitter, so that by emitting only the stray light to the photo detector for detecting stray light, the kind determination of the optical disc can be securely executed based on the amount of the stray light.

According to the embodiment of the present invention, an optical pickup and an optical disc apparatus are achieved in that a polarization optical element changes the polarization direction of only stray light included in a reflected light beam, and the stray light is separated from focused light by a polarization beam splitter, so that by emitting only the stray light to a photo detector for detecting stray light, the kind determination of the optical disc can be securely executed based on the amount of the stray light.

### BRIEF DESCRIPTION OF THE DRAWINGS

FIG. 1 is a schematic block diagram of the whole configuration of an optical disc apparatus according to an embodiment of the present invention;

FIG. 2 is a schematic block diagram of the configuration of an optical pickup according to the embodiment of the present invention;

FIG. 3 is a schematic drawing of the structure of a spherical-aberration correcting element to be mounted on the optical pickup;

FIG. 4 is a schematic drawing of the structure of a photo detector for detecting a signal;

FIGS. 5A and 5B are schematic drawings of the structure of a polarization optical element;

FIG. 6 is a characteristic graph showing the optical power of detected light when the boundary surface is formed of a metallic thin film;

FIG. 7 is a characteristic graph showing the optical power of detected light when the boundary surface is formed of a dielectric substance;

FIGS. 8A and 8B are schematic drawings illustrating spots of focused light and stray light;

FIG. 9 is a schematic drawing of the structure of a photo detector for detecting stray light;

FIGS. 10A to 10C are schematic drawings illustrating the relationship between the photo detector for detecting stray light and stray light spots;

FIG. 11 is a schematic drawing of the structure of a photo detector for detecting stray light according to another embodiment; and

FIGS. 12A to 12C are schematic drawings illustrating the relationship between the photo detector for detecting stray light according to the other embodiment and stray light spots.

### DESCRIPTION OF THE PREFERRED EMBODIMENTS

An embodiment of the present invention will be described below in detail with reference to the drawings.

### Embodiment

### (1) Optical Disc Apparatus Configuration

(1-1) The Whole Configuration of Optical Disc Apparatus

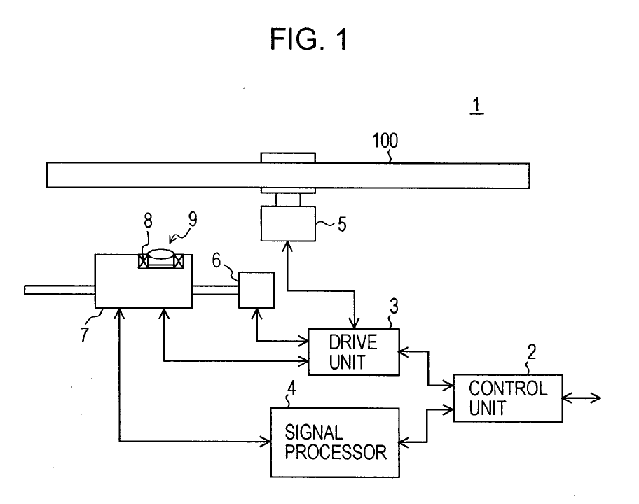

Referring to FIG. 1, an optical disc apparatus 1 according to an embodiment of the present invention can reproduce information from an optical disc 100 of one to four layered BD.

The optical disc apparatus 1 is totally controlled by a control unit 2. When the control unit 2 receives reproducing instructions from an outside instrument (not shown) in a state that the optical disc 100 is mounted thereon, the control unit 2 instructs a drive unit 3 and a signal processor 4 to read out information stored in the optical disc 100.

In practice, under the control of the control unit 2, the drive unit 3 rotates the optical disc 100 at a desired rotational speed with a spindle motor 5; largely moves an optical pickup 7 in a tracking direction, which is the radial direction of the optical disc 100, with a sled motor 6; and further finely moves an objective lens 9 in two directions of a focusing direction and the tracking direction, which are directions moving the objective lens 9 close to and separating from the optical disc 100, with a two-axis actuator 8.

Simultaneously, the signal processor 4 irradiates a desired track of the optical disc 100 with a predetermined light beam from the objective lens 9 using the optical pickup 7 so as to produce a reproducing signal based on the detected reflection light. Then, the reproducing signal is fed to the outside instrument (not shown) via the control unit 2.

Namely, the optical pickup 7 condenses a light beam with a wavelength corresponding to the kind of the mounted optical disc using an objective lens unit 9 so as to radiate an access target recording layer by focusing the light beam thereon (this recording layer is referred to as an in-focus recoding layer). Simultaneously, the light beam, including a recording signal component (referred to as a signal light beam) reflected from the in-focus recoding layer, is received by the objective lens unit 9 so as to produce various detection signals by photo-electric conversion for supplying them to the signal processor 4.

The drive unit 3 drives the two-axis actuator 8 on the basis of a focus error signal and a tracking error signal supplied from the signal processor 4. The signal processor 4 also executes predetermined signal processing on a reproducing signal supplied from the optical pickup 7 so as to outside output the reproducing signal via the control unit 2.

(1-2) Configuration of Optical Pickup

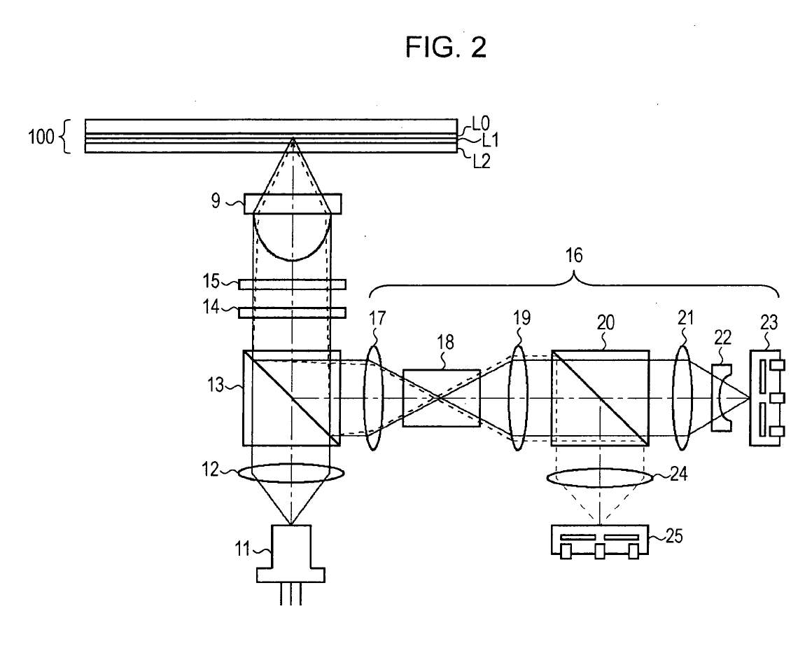

As shown in FIG. 2, the optical pickup 7 emits a light beam with a wavelength corresponding to the kind of the mounted optical disc 100 from a laser diode 11 as a light source of the light beam. Then, the light beam is substantially collimated from a divergent beam by a collimator lens 12 so as to enter a polarization beam splitter 13.

The polarization beam splitter 13 passes the light beam from the collimator lens 12 therethrough corresponding to the polarization direction of the light beam so as to emit the light beam to a spherical-aberration correcting element 14. This spherical-aberration correcting element 14 may include a liquid crystal phase plate like described in “M. Iwasaki, M. Ogasawara, and S. Ohtaki, “A New Liquid Crystal Panel for Spherical Aberration Compensation,” Technical Digest of Optical Data Storage Topical Meeting, Santa Fe, pp. 103(2001)”.

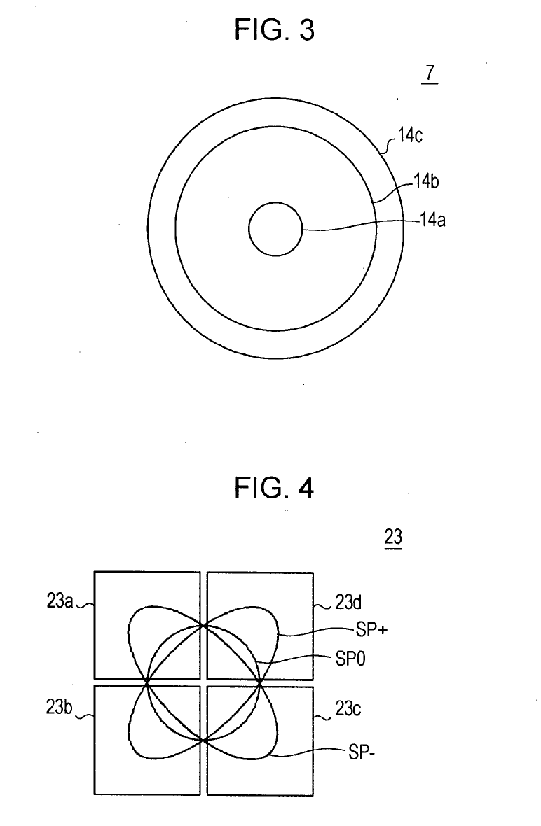

The spherical-aberration correcting element 14 made of such a liquid crystal phase plate, as shown in FIG. 3, includes electrodes 14a, 14b, and 14c arranged in a concentric configuration with different diameters, and high-resistivity and light-transmission ITO (indium tin oxide) films provided between the electrodes 14a, 14b, and 14c, so that an arbitrary voltage can be applied across the electrodes opposing each other via a substrate having liquid crystal enclosed therein. The spherical-aberration correcting element 14 can generate a wavefront substantially equivalent to the correction value of the spherical aberration produced in accordance with the thickness difference of the cover layer of the BD (light-transmissible protection layer).

Hence, the control unit 2 (FIG. 1) of the optical disc apparatus 1 can appropriately correct the light beam aberration generated in the cover layer by controlling the voltage applied to the electrodes 14a, 14b, and 14c in accordance with the position of an access target recording layer and the thickness of the cover layer corresponding to a format in the optical disc 100. The material of the spherical-aberration correcting element 14 is not limited to the liquid crystal phase plate, so that by the movement of other optical elements having the same function, such as an expander lens and a collimator lens, the spherical aberration may be corrected.

Then, the optical pickup 7 converts the light beam corrected in aberration by the spherical-aberration correcting element 14 into circular polarized light from linear polarized light with a quarter undulation plate 15, and further condenses the light beam with the objective lens 9 with a numerical aperture (NA) of 0.85 so as to irradiate the recording layer of the optical disc 100 with the light beam.

Furthermore, the optical pickup 7 receives the light beam reflected from the recording layer of the optical disc 100 with the objective lens 9, and the light beam is converted into a linear polarized beam with a polarizing direction perpendicular to that in the approaching route by the quarter undulation plate 15 so as to enter the polarization beam splitter 13 again. The reflected light beam is reflected at a right angle by the polarization beam splitter 13 based on the polarizing direction so as to enter a received ray system 16.

A condenser lens 17 in the received ray system 16 condenses the reflected light beam into the center of a polarization optical element 18. The reflected light beam, which is convergent light, incident in the polarization optical element 18 is converted into diffused light at the center of the polarization optical element 18 so as to emit from the polarization optical element 18. At this time, the polarization optical element 18 changes the polarization direction of only the stray light component included in the reflected light beam, as will be described later in detail.

The reflected light beam emitted from the polarization optical element 18 is collimated by a lens 19 so as to enter a polarization beam splitter 20. The polarization beam splitter 20 separates the focused light component from the stray light component included in the reflected light beam based on the respective polarization directions. That is, the polarization beam splitter 20 makes the focused light component included in the reflected light beam proceed straight based on its polarization direction, while makes the stray light component, which is changed in its polarization direction by the polarization optical element 18, reflect at a right angle and enter a condenser lens 24 based on its polarization direction.

The focused light proceeding straight through the polarization beam splitter 20 is condensed by a condenser lens 21 and is focused on a photo detector for detecting a signal 23 via a cylindrical lens 22. Then, the photo detector for detecting a signal 23 produces various detecting signals in accordance with the amount of received focused light so as to feed them to the signal processor 4 (FIG. 4).

The signal processor 4 produces a reproducing signal, a focus error signal, a tracking error signal, and a spherical aberration correcting signal, based on the various detecting signals supplied from the photo detector for detecting a signal 23 so as to output the reproducing signal to an external instrument via the control unit, and to output the focus error signal, the tracking error signal, and the spherical aberration correcting signal to the drive unit 3 (FIG. 1). Then, the drive unit 3 moves the objective lens 9 in a focusing direction and a tracking direction by driving the two-axis actuator 8 based on the focus error signal and the tracking error signal, while drives the spherical-aberration correcting element 14 based on the spherical aberration correcting signal.

On the other hand, the stray light reflected from the polarization beam splitter 20 is condensed by the condenser lens 24 and is focused on a photo detector for detecting stray light 25. Then, the photo detector for detecting stray light 25 produces a stray light detecting signal in accordance with the amount of stray light so as to supply it to the signal processor 4 (FIG. 1).

The signal processor 4 determines the number of layers of the optical disc 100 based on the stray light detecting signal supplied from the photo detector for detecting stray light 25 so as to inform the control unit 2 of the number of layers of the optical disc 100. Then, the control unit 2 regulates the laser power of the optical pickup 7 and the spherical aberration correction value in accordance with the number of layers of the optical disc 100.

Next, the computation processing on the various detection signals produced in the photo detector for detecting a signal 23 will be described. Means for obtaining a focal-point error signal FES herein employs an astigmatic method and means for obtaining a tracking error signal TES herein employs a phase contrast method. Alternatively, it is obvious that other methods, such as a knife-edge method and a spot-size method, may incorporate a focal-point error signal method and various methods, such as a push-pull method, a three-beam method, and a differential push-pull method, may incorporate a tracking error signal detecting method.

As shown in FIG. 4, the photo detector for detecting a signal 23 includes four-divided light-receiving regions 23a to 23d, and light beams incident in the light-receiving regions 23a to 23d are photo-electrically converted so as to produce signals A to D, respectively. A spot shape received by the photo detector 23 becomes a focused spot SPO that exhibits a substantial circular intensity distribution during focusing, and becomes a non-focused spot SP+ or SP− that exhibits a substantial elliptical intensity distribution having the major axis in a diagonal direction during non-focusing.

Hence, by computing the signals A to D according to the following equation (1), a focal-point error signal FES can be produced that exhibits a so-called S-shaped waveform in which the level is zero during focusing and the level changes in ± directions during non focusing:
FES=(A+C)−(B+D) (1).

The optical disc apparatus 1 according to the embodiment corresponds to a three-layered BD-ROM disc as a multi-layered information recording medium. From a reproduction-only optical disc having information pit columns formed in advance like the BD-ROM disc, a tracking error signal TES is produced by the phase contrast method according to the following equation (2):
TES=φ(A+C)−φ(B+D) (2),
where φ denotes an operator of a signal phase.

The reproducing signal RFS is also produced by adding the output signals A to D of the entire light-receiving regions 23a to 23d according to the following equation (3):
FES=A+B+C+D (3).

### (2) Polarization Optical Element Configuration and Stray Light Separation

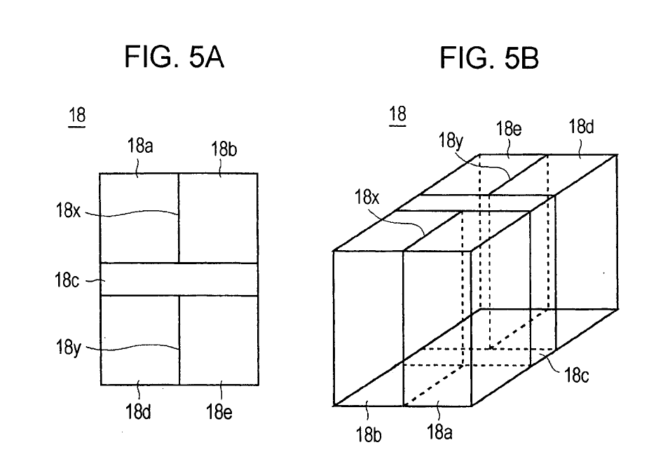

Then, the configuration of the polarization optical element 18 and the separation of stray light from focused light will be described in detail. FIGS. 5A and 5B show the configuration of the polarization optical element 18 composed of five small prisms 18a to 18e bonded together and having the same refractive index n_{g}.

The small prisms 18a and 18b and the small prisms 18d and 18e are respectively bonded together with an optical material, such as an adhesive transparent to the wavelength of laser light, a dielectric thin film, or a metallic thin film having absorbency, therebetween. Thereby, between the small prisms 18a and 18b and between the small prisms 18d and 18e, boundary surfaces 18x and 18y made of the above-mentioned optical material are formed, respectively. The refractive index of the optical material forming the boundary surfaces 18x and 18y is designated by n₁.

The small prism 18c is bonded to the small prisms 18a and 18b and to the small prisms 18d and 18e with the optical material, such as the adhesive transparent to the wavelength of laser light, the dielectric thin film, or the metallic thin film having absorbency, therebetween. This optical material suppresses the reflection index during transmission by selecting its refractive index n₂ as close to the refractive index n_{g} of the five small prisms 18a to 18e as possible.

As described above, the polarization optical element 18 is positioned so that the center of the small prism 18c agrees with the focal point of the reflected light beam condensed by the condenser lens 17 while the boundary surfaces 18x and 18y are positioned backward and forward the focal point of the reflected light beam on a plane including the optical axis of the reflected light beam.

According to the embodiment, the NA of the objective lens 9 is 0.85; the NA of the condenser lens 17 is 0.1; and signal layers of the three-layered BD-ROM disc are sequentially called as an L0 layer, an L1 layer, and an L2 layer from the side remote from the objective lens. In FIG. 2, a state is shown in that when the focal point is controlled so that the focal point position of the objective lens 9 agrees with the L1 layer (i.e., the L1 layer becomes the in-focus layer), a light beam condensed to the L1 layer is reflected by the L1 layer.

As described above, the light beam reflected by the L1 layer i.e., the focused light, is substantially collimated by the objective lens 9, and after being condensed at the center of the polarization optical element 18, the focused light beam is converted into diffused light.

The focused light beam at this time, as shown in the solid lines of FIG. 2, passes through the interior of the polarization optical element 18 without contacting with any of the boundary surfaces 18x and 18y because its focal point is located at the center of the polarization optical element 18. Thereby, the boundary surfaces 18x and 18y have no effect on the focused light. In addition, since the boundary surfaces 18x and 18y are only formed until the positions spaced from the center of the polarization optical element 18 by the thickness of the small prism 18e, even if imperfect alignment of the signal light with the optical axis is generated, the boundary surfaces 18x and 18y have no effect on the focused light.

Whereas, the stray light comes in contact with the boundary surface 18x or 18y during passing through the polarization optical element 18. Referring to FIG. 2, the light beam condensed on the L1 layer, which is the in-focus layer, is reflected by the L0 layer on the rear side so as to become the stray light shown by the broken lines. Since the stray light from the L0 layer is reflected at a position deeper than that of the focal point of the light beam, it becomes not the collimated light but the slightly convergent light to pass through the optical system of the optical pickup 7 and to enter the polarization optical element 18 by being condensed with the condenser lens 17.

As described above, since this stray light enters the condenser lens 17 as the convergent light, its focal point due to the condenser lens 17 is located at a position nearer than the center of the polarization optical element 18. Thereby, the stray light incident in the polarization optical element 18 is emitted from the polarization optical element 18 after once contacting with the boundary surface 18x, and at this time, the boundary surface 18x reflects, transmits, or absorbs the stray light.

Although not shown in FIG. 2, the light, straying from the light condensed on the L1 layer due to the reflection on the nearer L2 layer, passes through the optical system of the optical pickup 7 as the slightly convergent light so as to be condensed by the condenser lens 17. The focal point due to the condenser lens 17 is located at a position deeper than the center of the polarization optical element 18, so that the stray light incident in the polarization optical element 18 is emitted from the polarization optical element 18 after once contacting with the boundary surface 18y.

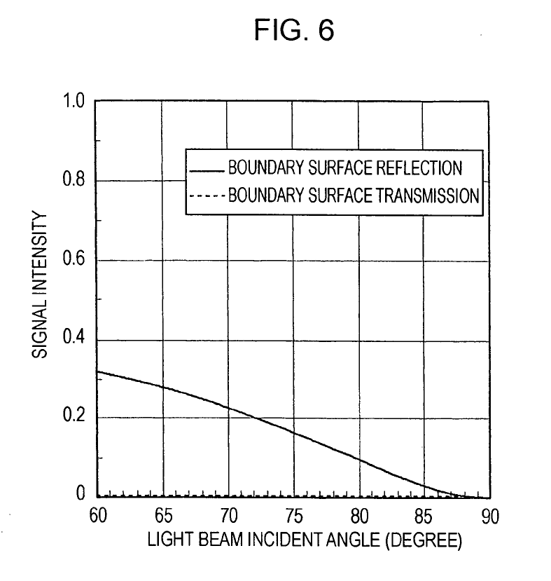

FIG. 6 shows the calculated results of the amount of the light incident in the photo detector for detecting a signal 23 after passing through the polarization beam splitter 20 among the reflected light and the transmitted light due to the boundary surface 18x or 18y, where the boundary surfaces 18x and 18y are made of a chrome thin film with a thickness of 50 nm; the refractive index of the boundary surface 18x or 18y n₁=2.05+2.90i; and the refractive index of the small prisms 18a to 18e n_{g}=1.53. That is, the incident light angle in the boundary surface 18x or 18y is plotted in abscissa and the signal intensity received by the photo detector for detecting a signal 23 is plotted in ordinate, and the reflected light intensity in the boundary surface 18x or 18y is normalized to be 1.

Since the absorption due to the boundary surface 18x or 18y made of a metallic thin film is large in this case, the light transmitting through the boundary surface 18x or 18y scarcely exists and the reflection and the absorption are mainly generated.

That is, when the incident light angle in the boundary surface 18x or 18y is small, the light reflected from the boundary surface 18x or 18y passes through the polarization beam splitter 20 so as to enter the photo detector for detecting a signal 23. Whereas, as the incident light angle increases, the phase shift is generated in the reflected light to change the polarization direction, so that the amount of light reflected by the polarization beam splitter 20 and entering the photo detector for detecting stray light 25 increases while the amount of light entering the photo detector for detecting a signal 23 decreases. In particular, when the reflection angle is 85° or more, almost whole quantity of the light enters the photo detector for detecting stray light 25.

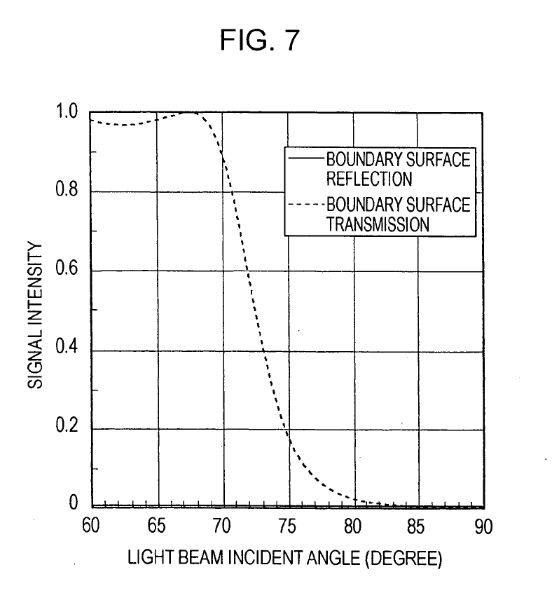

On the other hand, FIG. 7 shows the calculated results of the amount of the light incident in the photo detector for detecting a signal 23 after passing through the polarization beam splitter 20 among the reflected light and the transmitted light due to the boundary surface 18x or 18y, where the boundary surfaces 18x and 18y are made of a dielectric thin film or an adhesive layer with a thickness of 500 nm; the refractive index of the boundary surfaces 18x and 18y n₁=1.47; and the refractive index of the small prisms 18a to 18e n_{g}=1.53.

In this case, differently from the case where the boundary surfaces 18x and 18y are made of a metallic thin film (FIG. 6), the absorption in the boundary surfaces 18x and 18y is not generated. Since the refractive index difference (n₁ vs. n_{g}) is small, when the reflection angle is small, almost whole quantity of the light transmits through the boundary surfaces and the polarization beam splitter 20 so as to enter the photo detector for detecting a signal 23. Whereas, when the light incident angle increases over 70°, the total reflection is generated even on the boundary surfaces. Since the polarization direction is changed due to the total reflection also in this case, the amount of the light reflected by the polarization beam splitter 20 and entering the photo detector for detecting stray light 25 is increased while the amount of light entering the photo detector for detecting a signal 23 extremely decreases.

According to the embodiment, the numerical aperture of the condenser lens 17 is 0.1. Under this condition, the angle between the most outside light beam and the optical axis is about 6°, and the angle within the polarization optical element 18 is 4° or less because of the light refraction on the boundary plane between air and the optical material. Hence, the incident angle of the light beam in the boundary surfaces 18x and 18y of the polarization optical element 18 becomes 86° or more, so that according to the calculated results shown in FIGS. 6 and 7, even when the boundary surfaces 18x and 18y are made of any thin film, almost whole quantity of the stray light is reflected by the polarization beam splitter 20 to enter the photo detector for detecting stray light 25. Namely, the stray light is separated from the focused light.

The stray light generated in the L0 layer on the deeper side and in the L2 layer on the nearer side when the L1 layer is the in-focus layer has been described as above. However, the stray light generated in the L1 layer and in the L2 layer on the nearer side when the L0 layer is the in-focus layer as well as the stray light generated in the L1 layer and in the L0 layer on the deeper side when the L2 layer is the in-focus layer can be separated from the focused light in the same way.

### (3) Photo Detector for Detecting Stray Light Configuration

Then, the configuration of the photo detector for detecting stray light 25 and the method for determining the number of layers of the optical disc 100 by the photo detector for detecting stray light 25 will be described.

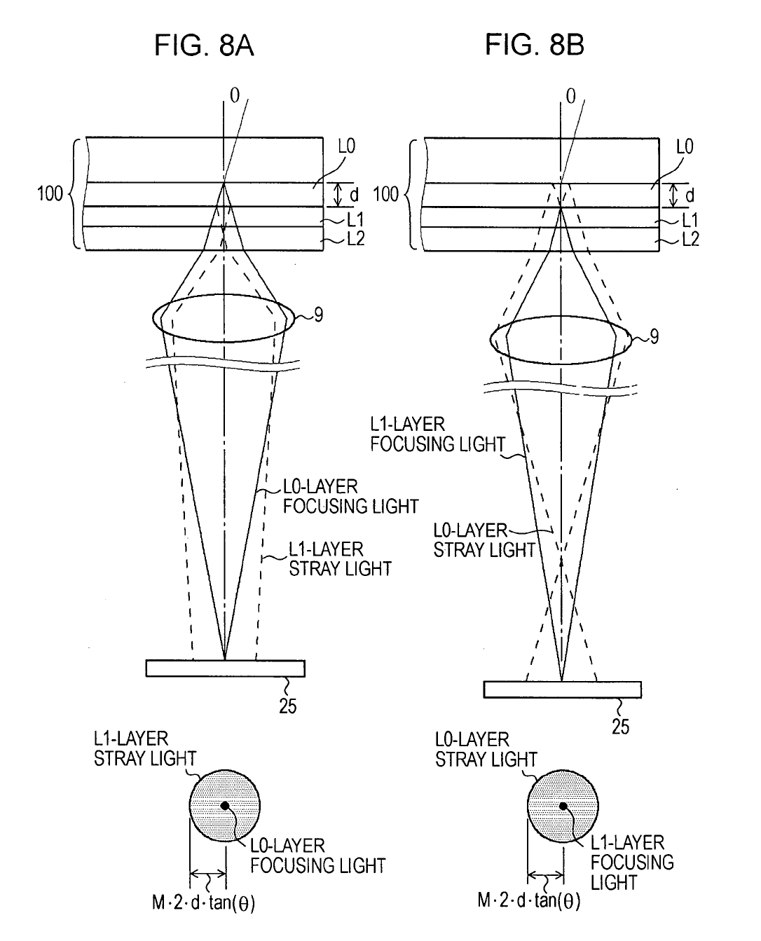

In the photo detector for detecting stray light 25, the light receiving plane is positioned at a position optically equivalent to that of the light receiving plane of the photo detector for detecting a signal 23. That is, when the focused light is assumed to be reflected by the polarization beam splitter 20 to enter the photo detector for detecting stray light 25, as shown by the solid lines of FIGS. 8A and 8B, the light receiving plane of the photo detector for detecting stray light 25 is positioned so as to agree with the focal point of the focused light. In addition, in FIGS. 8A and 8B, optical elements other than the objective lens 9 are omitted.

FIG. 8A shows a state of light focused on the L0 layer, and the stray light due to the L1 layer and shown by the broken lines forms a spot larger than that of the focused light on the light receiving plane of the photo detector for detecting stray light 25. Although not shown, the stray light due to the L2 layer forms a spot larger than that of the stray light due to the L1 layer on the light receiving plane. On the other hand, FIG. 8B shows a state of light focused on the L1 layer, and the stray light due to the L0 layer and shown by the broken lines forms a spot larger than that of the focused light on the light receiving plane of the photo detector for detecting stray light 25.

As described above, since the focused light does not enter the photo detector for detecting stray light 25, if the incident light cannot be detected by the photo detector for detecting stray light 25, the mounted optical disc 100 is determined to be a monolayer optical disc.

The size of the stray light spot formed on the light receiving plane of the photo detector for detecting stray light 25 substantially changes in proportion to the space between a non in-focus layer and an in-focus layer, so that the layer space and the number of layers of the optical disc 100 can be determined based on the spot size and the received light amount on the light receiving plane of the photo detector for detecting stray light 25.

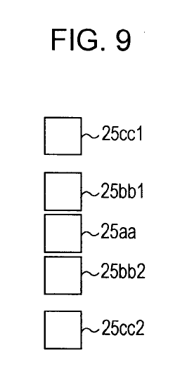

As shown in FIG. 9, the photo detector for detecting stray light 25 includes five rectangular light receiving regions 25aa, 25bb1, 25bb2, 25cc1, and 25cc2 formed on the light receiving plane with the same area. The light receiving regions 25aa, 25bb1, 25bb2, 25cc1, and 25cc2 produce stray light detection signals AA, BB1, BB2, CC1, and CC2 by photo-electrically converting incident light, respectively.

The light receiving region 25aa of the photo detector for detecting stray light 25 is positioned so that its center substantially agrees with the center of the stray light condensed by the condenser lens 24. The light receiving regions 25bb1 and 25bb2 are point-symmetrically arranged with each other about the center of the light receiving region 25aa. Furthermore, the light receiving regions 25cc1 and 25cc2 are arranged outside the light receiving regions 25bb1 and 25bb2, respectively, as well as point-symmetrically with each other about the center of the light receiving region 25aa. Thereby, the light receiving regions 25aa, 25bb1, 25bb2, 25cc1, and 25cc2 are linearly arranged along the straight line passing the center of the stray light condensed by the condenser lens 24.

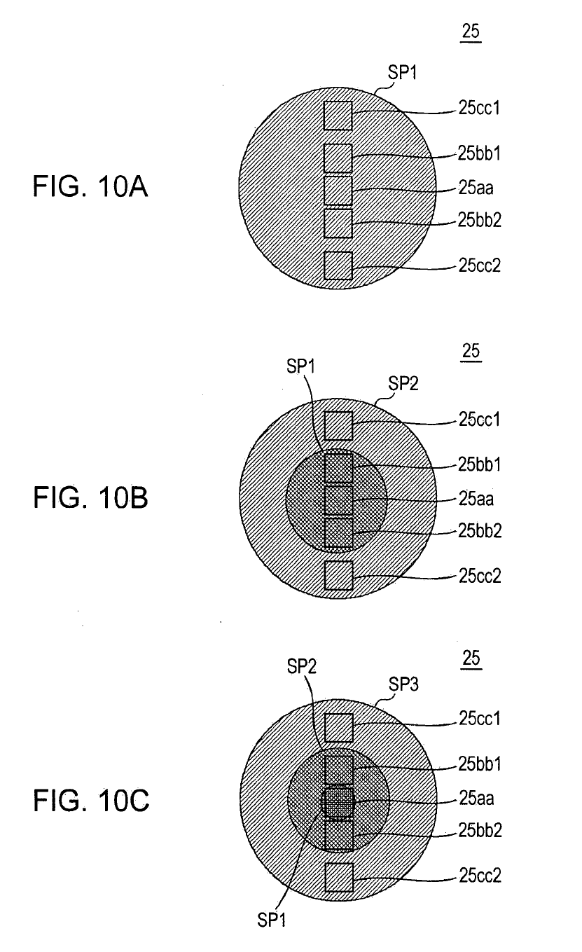

FIGS. 10A to 10C show examples of the spot formed by the stray light due to various optical discs 100 on the light receiving plane of the photo detector for detecting stray light 25.

FIG. 10A shows a spot of the stray light due to a two-layered optical disc in that a spot SP1 of the stray light reflected by the non in-focus layer adjacent to the in-focus layer is formed to cover the whole light receiving regions 25aa, 25bb1, 25bb2, 25cc1, and 25cc2.

In this case, since the light amount received by the respective light receiving regions 25aa, 25bb1, 25bb2, 25cc1, and 25cc2 is substantially the same, if the following equation (4) is satisfied, the optical disc 100 is determined to be a two-layered optical disc.
AA=BB1=BB2=CC1=CC2>0 (4)

On the other hand, FIG. 10B shows spots of the stray light due to a three-layered optical disc in that a spot SP1 of the stray light reflected by a non in-focus layer adjacent to the in-focus layer is formed to cover the light receiving regions 25aa, 25bb1, and 25bb2, while a spot SP2 of the stray light reflected by a non in-focus layer secondly next to the in-focus layer is formed to cover the whole light receiving regions 25aa, 25bb1, 25bb2, 25cc1, and 25cc2.

In this case, the spot SP1 and the spot SP2 enter the light receiving regions 25aa, 25bb1, and 25bb2 while only the spot SP2 enters the light receiving regions 25cc1 and 25cc2, so that if the following equation (5) is satisfied, the optical disc 100 is determined to be a three-layered optical disc.
AA=BB1=BB2>CC1=CC2>0 (5)

FIG. 10C shows spots of the stray light due to a four-layered optical disc in that a spot SP1 of the stray light reflected by a non in-focus layer adjacent to the in-focus layer is formed to cover only the light receiving region 25aa, while a spot SP2 of the stray light reflected by a non in-focus layer secondly next to the in-focus layer is formed to cover the light receiving regions 25aa, 25bb1, and 25bb2, and moreover, a spot SP2 of the stray light reflected by a non in-focus layer thirdly next to the in-focus layer is formed to cover the whole light receiving regions 25aa, 25bb1, 25bb2, 25cc1, and 25cc2.

In this case, the spot SP1, the spot SP2, and the spot SP3 enter the light receiving region 25aa, the spot SP2 and the spot SP3 enter the light receiving regions 25bb1 and 25bb2, and only the spot SP3 enters the light receiving regions 25cc1 and 25cc2, so that if the following equation (6) is satisfied, the optical disc 100 is determined to be a four-layered optical disc.
AA>BB1=BB2>CC1=CC2>0 (6)

Since when the optical disc 100 is a monolayer optical disc, the stray light is not generated, if the following equation (7) is satisfied, the optical disc 100 is determined to be a monolayer optical disc.
AA=BB1=BB2=CC1=CC2=0 (7)

When surface reflected light reflected from the surface of the optical disc 100 and other unnecessary light enter the photo detector for detecting stray light 25, an appropriate threshold value t may be set in consideration of the amount of the unnecessary light entering the light receiving regions 25aa, 25bb1, 25bb2, 25cc1, and 25cc2.

That is, if the following equation (4′) is satisfied, the optical disc 100 is determined to be a two-layered optical disc.
AA=BB1=BB2=CC1=CC2>t (4′)

If the following equation (5′) is satisfied, the optical disc 100 is determined to be a three-layered optical disc.
AA=BB1=BB2>CC1=CC2>t (5′)

If the following equation (6′) is satisfied, the optical disc 100 is determined to be a four-layered optical disc.
AA>BB1=BB2>CC1=CC2>t (6′)

If the following equation (7′) is satisfied, the optical disc 100 is determined to be a monolayer optical disc.
AA=BB1=BB2=CC1=CC2≦t (7′)

The signal processor 4 (FIG. 1) of the optical disc apparatus 1 determines the number of layers of the optical disc 100 on the basis of the stray light detection signals AA, BB1, BB2, CC1, and CC2 from the photo detector for detecting stray light 25 and using the above-mentioned equations (4) to (7) or the equations (4′) to (7′) so as to feed the layer number information to the control unit 2 before focus servo control accompanying the recording and reproducing processing. Then, the control unit 2 regulates the laser power and the spherical aberration correction value of the optical pickup 7 in accordance with the number of layers of the recording layer on the basis of the layer number information supplied from the signal processor 4.

### (4) Operation and Effect

In the optical pickup 7 configured as above, the light beam reflected from the optical disc 100 is condensed by the condenser lens 17 so as to enter the polarization optical element 18.

The polarization optical element 18 is provided with the boundary surfaces 18x and 18y positioned backward and forward the focal point of the reflected light beam on a plane including the optical axis of the reflected light beam and spaced by a predetermined distance. The focal point of the stray light reflected by the non in-focus recording layer is positioned backward or forward the focal point of the focused light. Thereby, the focused light passes through the polarization optical element 18 without contacting with the boundary surface 18x or 18y whereas, the stray light comes in contact with the boundary surface 18x or 18y.

Thereby, the polarization optical element 18 reflects only the stray light included in the reflected light beam by the boundary surface 18x or 18y so as to change its polarization direction, so that in the subsequent stage of the polarization beam splitter 20, the stray light is separated from the focused light. Then, only the focused light is emitted to the photo detector for detecting a signal 23 while only the stray light is emitted to the photo detector for detecting stray light 25.

Then, the optical pickup 7 determines the number of layers of the optical disc 100 from the shape of the stray light spot formed on the light receiving plane of the photo detector for detecting stray light 25 on the basis of the stray light detection signals AA, BB1, BB2, CC1, and CC2 indicating the amount of the stray light received by the photo detector for detecting stray light 25.

By the configurations described above, the polarization optical element 18 changes the polarization direction of only the stray light component in the reflected light beam, so that the polarization beam splitter 20 separates the focused light from the stray light so as to emit only the stray light to the photo detector for detecting stray light 25. Thereby, the determination of the number of layers of the optical disc 100 based on the amount of the stray light can be executed more securely than in the related art.

### (5) Other Embodiments

According to the embodiment described above, the optical disc apparatus 1 corresponding to the optical disc 100 having four recording layers and incorporating the invention has been described. However, the present invention is not limited to the embodiment, so that the present invention may be widely incorporated in an optical disc apparatus corresponding to an optical disc having a plurality of recording layers, such as an optical disc having 2 or 3 recording layers and an optical disc having 5 or more recording layers.

According to the embodiment described above, the optical disc apparatus 1 corresponding to Blu-ray Disc™ and incorporating the invention has been described. However, the present invention is not limited to this, so that the present invention may be widely incorporated in various optical discs, such as DVD and CD.

According to the embodiment described above, the photo detector for detecting stray light 25 is provided with the five rectangular light receiving regions 25aa, 25bb1, 25bb2, 25cc1, and 25cc2 formed with the same area. However, the present invention is not limited to this, so that other various numbers of light receiving regions with other various shapes may be provided in the photo detector for detecting stray light 25.

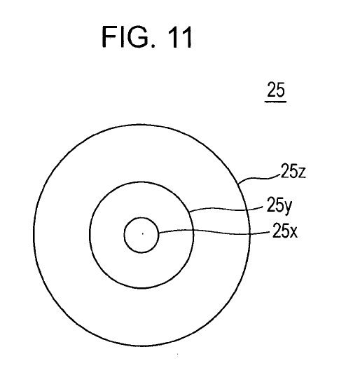

For example, FIG. 11 shows a photo detector for detecting stray light 25 having light receiving regions arranged in a concentric configuration, which are a circular light receiving region 25x, an annular light receiving region 25y formed to surround the light receiving region 25x, and an annular light receiving region 25z formed to surround the light receiving region 25y. The light beams incident in the light-receiving regions 25x to 25z are photo-electrically converted so as to produce stray light detection signals X to Z, respectively so as to feed them to the signal processor 4. The light receiving region 25x of the photo detector for detecting stray light 25 is positioned so that its center substantially agrees with the center of the stray light condensed by the condenser lens 24.

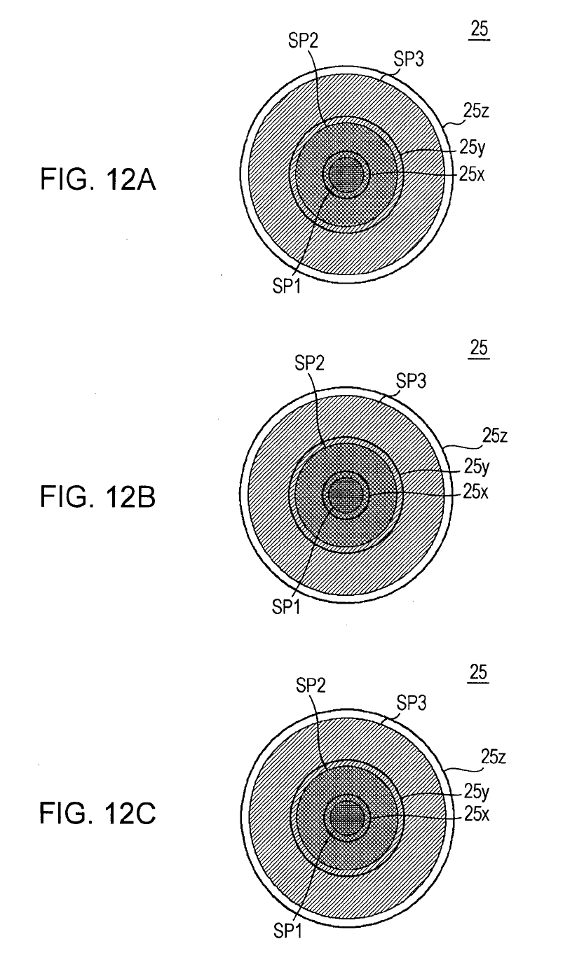

FIGS. 12A to 12C show examples of the spot formed by the stray light due to various optical discs 100 on the light receiving plane of the photo detector for detecting stray light 25.

FIG. 12A shows a spot of the stray light due to a two-layered optical disc in that a spot SP1 of the stray light reflected by the non in-focus layer adjacent to the in-focus layer is formed to cover the whole light receiving regions 25x, 25y, and 25z.

On the other hand, FIG. 12B shows spots of the stray light due to a three-layered optical disc in that a spot SP1 of the stray light reflected by a non in-focus layer adjacent to the in-focus layer is formed to cover the light receiving regions 25x and 25y, while a spot SP2 of the stray light reflected by a non in-focus layer secondly next to the in-focus layer is formed to cover the whole light receiving regions 25x, 25y, and 25z.

FIG. 12C shows spots of the stray light due to a four-layered optical disc in that a spot SP1 of the stray light reflected by a non in-focus layer adjacent to the in-focus layer is formed to cover only the light receiving region 25x, while a spot SP2 of the stray light reflected by a non in-focus layer secondly next to the in-focus layer is formed to cover the light receiving regions 25x and 25y, and moreover, a spot SP2 of the stray light reflected by a non in-focus layer thirdly next to the in-focus layer is formed to cover the whole light receiving regions 25x, 25y, and 25z.

In the photo detector for detecting stray light 25 having such light receiving regions arranged in a concentric configuration, since the light receiving regions 25x, 25y, and 25z have respectively different light receiving areas, when determining the number of layers in the signal processor 4 (FIG. 1), the stray light detection signals X to Z need to be normalized.

Furthermore, according to the embodiment described above, the optical pickup of the optical disc apparatus 1 incorporating the invention has been described; the invention is not limited to this, so that other stray light removing elements configured in various ways may be incorporated in the invention. That is, a stray light removing element 30 may not be assembled in the optical pickup 7 and the optical pickup 7 may not be assembled in the optical disc apparatus 1.

The embodiments of the present invention may be broadly applied to an optical disc apparatus having a multi-layered optical disc.

It should be understood by those skilled in the art that various modifications, combinations, sub-combinations and alterations may occur depending on design requirements and other factors insofar as they are within the scope of the appended claims or the equivalents thereof.

What is claimed is:

1. An optical pickup configured to irradiate an optical disc having a plurality of recording layers with a light beam to receive a reflected light beam reflected from the recording layer of the optical disc, the optical pickup comprising:
an objective lens configured to condense a light beam emitted from a light source onto an in-focus recording layer of the optical disc and to receive the reflected light beam;
a condenser lens configured to condense the reflected light beam received by the objective lens;
a polarization optical element configured to include boundary surfaces positioned backward and forward of the focal point of focused light condensed by the condenser lens, the focused light being reflected by the in-focus recording layer in the reflected light beam on a plane including the optical axis of the reflected light beam condensed by the condenser lens, and spaced from the focal point by a predetermined distance so as to change a polarization direction of stray light included in the reflected light beam by reflecting only the stray light in the reflected light beam reflected from a non in-focus recording layer by the boundary surfaces;
separating means for separating the stray light from the focused light based on the polarization direction by emitting the reflected light beam emitted from the polarization optical element therein;
stray light detecting means having a plurality of light receiving regions for detecting the amount of the stray light separated by the separating means; and
disc kind determining means for determining a kind of the optical disc based on amounts of the stray light respectively detected in the plurality of light receiving regions.

2. The optical pickup according to claim 1, wherein the disc kind determining means determines the number of layers of the optical disc based on amounts of the stray light respectively detected in the plurality of light receiving regions.

3. The optical pickup according to claim 1, wherein the disc kind determining means determines a space between recording layers of the optical disc on the basis of the amounts of the stray light respectively detected in the plurality of light receiving regions.

4. The optical pickup according to claim 1, wherein a power of the light beam is controlled in accordance with the kind of the optical disc determined by the disc kind determining means.

5. The optical pickup according to claim 1, wherein a spherical aberration of the light beam condensed by the objective lens is corrected in accordance with the kind of the optical disc determined by the disc kind determining means.

6. An optical disc apparatus configured to irradiate an optical disc having a plurality of recording layers with a light beam to receive a reflected light beam reflected from the recoding layer of the optical disc, the optical disc apparatus comprising:
an objective lens configured to condense a light beam emitted from a light source onto an in-focus recording layer of the optical disc and to receive the reflected light beam;
a condenser lens configured to condense the reflected light beam received by the objective lens;
a polarization optical element configured to include boundary surfaces positioned backward and forward of the focal point of focused light condensed by the condenser lens, the focused light being reflected by the in-focus recording layer in the reflected light beam on a plane including the optical axis of the reflected light beam condensed by the condenser lens, and spaced from the focal point by a predetermined distance so as to change a polarization direction of stray light included in the reflected light beam by reflecting only the stray light in the reflected light beam reflected from a non in-focus recording layer by the boundary surfaces;
separating means for separating the stray light from the focused light based on the polarization direction by emitting the reflected light beam emitted from the polarization optical element therein;
stray light detecting means having a plurality of light receiving regions for detecting the amount of the stray light separated by the separating means; and
disc kind determining means for determining a kind of the optical disc based on amounts of the stray light respectively detected in the plurality of light receiving regions.

7. An optical pickup configured to irradiate an optical disc having a plurality of recording layers with a light beam to receive a reflected light beam reflected from the recoding layer of the optical disc, the optical pickup comprising:
an objective lens configured to condense a light beam emitted from a light source onto an in-focus recording layer of the optical disc and to receive the reflected light beam;
a condenser lens configured to condense the reflected light beam received by the objective lens;
a polarization optical element configured to include boundary surfaces positioned backward and forward of the focal point of focused light condensed by the condenser lens, the focused light being reflected by the in-focus recording layer in the reflected light beam on a plane including the optical axis of the reflected light beam condensed by the condenser lens, and spaced from the focal point by a predetermined distance so as to change a polarization direction of stray light included in the reflected light beam by reflecting only the stray light in the reflected light beam reflected from a non in-focus recording layer by the boundary surfaces;
a polarization beam splitter configured to separate the stray light from the focused light based on the polarization direction by emitting the reflected light beam emitted from the polarization optical element therein;
a photo detector having a plurality of light receiving regions for detecting the amount of the stray light separated by the polarization beam splitter; and
a signal processor for determining a kind of the optical disc based on amounts of the stray light respectively detected in the plurality of light receiving regions.

8. An optical disc apparatus configured to irradiate an optical disc having a plurality of recording layers with a light beam to receive a reflected light beam reflected from the recoding layer of the optical disc, the optical disc apparatus comprising:
an objective lens configured to condense a light beam emitted from a light source onto an in-focus recording layer of the optical disc and to receive the reflected light beam;
a condenser lens configured to condense the reflected light beam received by the objective lens;
a polarization optical element configured to include boundary surfaces positioned backward and forward of the focal point of focused light condensed by the condenser lens, the focused light being reflected by the in-focus recording layer in the reflected light beam on a plane including the optical axis of the reflected light beam condensed by the condenser lens, and spaced from the focal point by a predetermined distance so as to change a polarization direction of stray light included in the reflected light beam by reflecting only the stray light in the reflected light beam reflected from a non in-focus recording layer by the boundary surfaces;
a polarization beam splitter configured to separate the stray light from the focused light based on the polarization direction by emitting the reflected light beam emitted from the polarization optical element therein;
a photo detector having a plurality of light receiving regions for detecting the amount of the stray light separated by the polarization beam splitter; and
a signal processor for determining a kind of the optical disc based on amounts of the stray light respectively detected in the plurality of light receiving regions.
